(19) United States
(12) Patent Application Publication
(10) Pub. No.: US 2025/0128975 A1
(43) Pub. Date: Apr. 24, 2025

(54) Multilayer Treatment Tank and Sewage Treatment System

(71) Applicant: Kubota Corporation, Osaka-shi (JP)

(72) Inventors: Soichiro Yatsugi, Amagasaki-shi, Hyogo (JP); Shinya Nagae, Chuo-ku, Tokyo (JP)

(21) Appl. No.: 18/685,692

(22) PCT Filed: Aug. 8, 2022
(86) PCT No.: PCT/JP2022/030253

§ 371 Date: Feb. 22, 2024

(30) Foreign Application Priority Data
Aug. 23, 2021 (JP) 2021-135908

(51) Int. Cl. C02F 3/30

(52) U.S. Cl. CPC C02F 3/301; C02F 2203/006; C02F 2209/005; C02F 2209/42; C02F 2301/08

(57) ABSTRACT

A multilayer treatment tank includes an aerobic tank in an upper layer and an anoxic tank in a lower layer. The multilayer treatment tank includes a first channel between the aerobic tank and the anoxic tank, a second channel between the anoxic tank and a tank different from the anoxic tank, and an urging device that urges a fluid. The first channel and the urging device are located to allow a flow into the anoxic tank from the aerobic tank through the first channel when the urging device is in operation. The second channel has an end being open in an upper surface of the anoxic tank. At an end of the first channel, a wall defining the first channel protrudes into the anoxic tank through the upper surface of the anoxic tank.

### CROSS-REFERENCE TO RELATED APPLICATIONS

This application is the United States national phase of International Application No. PCT/JP2022/030253 filed Aug. 8, 2022, and claims priority to Japanese Patent Application No. 2021-135908 filed Aug. 23, 2021, the disclosures of which are hereby incorporated by reference in their entireties.

### BACKGROUND OF THE INVENTION

### Field of the Invention

The present invention relates to a multilayer treatment tank and a sewage treatment system including multiple multilayer treatment tanks.

### Description of Related Art

A combination of multiple biological treatment processes has been used as a method for treating water such as domestic wastewater using activated sludge. Such a method typically uses multiple tanks (including an aerobic tank, an anoxic tank, and an anaerobic tank) with different environments using multiple microorganisms that are activated in different environments, and performs biological treatment in each tank while circulating treatment target water between these tanks. More specifically, multiple treatment tanks are typically used in biological treatment of sewage.

Japanese Unexamined Patent Application Publication No. 2020-54980 (Patent Literature 1) describes an organic wastewater treatment apparatus including an aerobic tank and an anoxic tank vertically arranged to reduce the area for installing the multiple treatment tanks. This technique for vertically arranging the aerobic tank and the anoxic tank successfully reduces the area for installing these two treatment tanks.
Patent Literature 1: Japanese Unexamined Patent Application Publication No. 2020-54980 (U.S. Patent Application Publication No. 2021/17210187)

### SUMMARY OF THE INVENTION

In the anoxic tank, denitrifying bacteria degrade nitrate ions to generate nitrogen gas. Effluent gas from the anoxic tank containing the nitrogen gas has an odor and is to be deodorized. The apparatus described in Patent Literature 1 structurally releases the gas (nitrogen gas) generated in the anoxic tank into the atmosphere through the aerobic tank. Thus, the effluent gas from the aerobic tank may have an odor. Such an apparatus thus involves deodorization of the effluent gas from the aerobic tank, which usually undergoes no deodorization, and thus increases the capacity used for the deodorization system.

The reaction state in the anoxic tank may be estimated by measuring the state of the effluent gas generated in the anoxic tank. However, in the apparatus in Patent Literature 1 in which the effluent gas from the anoxic tank and the effluent gas from the aerobic tank are mixed, the state of the effluent gas alone from the anoxic tank cannot be measured.

Thus, a multilayer treatment tank and a sewage treatment system including multiple tanks vertically arranged and that can separate the effluent gas from the anoxic tank and the effluent gas from the aerobic tank from each other have been awaited.

A multilayer treatment tank according to an aspect of the present invention is a multilayer treatment tank comprising an aerobic tank in an upper layer and an anoxic tank in a lower layer, the multilayer treatment tank comprising: a first channel between the aerobic tank and the anoxic tank; a second channel between the anoxic tank and a tank different from the anoxic tank; and an urging device configured to urge a fluid, the first channel and the urging device being located to allow a flow into the anoxic tank from the aerobic tank through the first channel when the urging device is in operation, the second channel having an end being open in an upper surface of the anoxic tank, the first channel being defined by a wall with an end extending through the upper surface into the anoxic tank.

A sewage treatment system according to an aspect of the present invention includes a plurality of multilayer treatment tanks, each of the plurality of multilayer treatment tanks including an aerobic tank in an upper layer, an anoxic tank in a lower layer, a first channel between the aerobic tank and the anoxic tank, and an urging device configured to urge a fluid, the plurality of multilayer treatment tanks forming a circulatory system in which the aerobic tanks and the anoxic tanks are alternately connected, the first channel and the urging device being located to allow a flow into the anoxic tank from the aerobic tank through the first channel when the urging device is in operation, the first channel being defined by a wall with an end extending through the upper surface into the anoxic tank, two multilayer treatment tanks of the plurality of multilayer treatment tanks adjacent to each other in the circulatory system being connected with a second channel between the anoxic tank included in one of the two multilayer treatment tanks and the aerobic tank included in another of the two multilayer treatment tanks, the second channel including an end being open in the upper surface of the anoxic tank, the second channel including a protruding portion located upward from an upper edge of the aerobic tank in each of the two multilayer treatment tanks connected with the second channel, the protruding portion having an upper surface being covered with a plate having an opening, the opening connecting with a third channel, the third channel in each of the two multilayer treatment tanks including a flowmeter to measure a flow velocity of gas flowing through the third channel

These structures including the multiple tanks that are arranged vertically can separate the effluent gas from the anoxic tank and the effluent gas from the aerobic tank from each other. This is because the wall surface defining the first channel protrudes into the anoxic tank through the upper surface of the anoxic tank at one end of the first channel, and the urging device constantly causes a downward water flow to restrict the gas generated in the anoxic tank from flowing into the first channel. The gas restricted from flowing into the first channel is less likely to block a flow from the aerobic tank toward the anoxic tank.

One or more aspects of the present invention will now be described. The scope of the present invention is not limited by the aspects described below.

In the multilayer treatment tank according to one aspect of the present invention, the upper surface of the anoxic tank is sloped, and the end of the second channel is at an upper end of the sloped upper surface.

This structure may more smoothly gather the gas generated in the anoxic tank to the second channel.

In the multilayer treatment tank according to one aspect of the present invention, the first channel includes a duct extending into the aerobic tank, the aerobic tank has a reference liquid level being set, as a liquid level in a normal operation state, the urging device includes a power unit located above the reference liquid level, and an urging unit located below the reference liquid level to urge the fluid when driven with power from the power unit, and the urging unit is accommodated in the duct.

In this structure, the duct restricts a flow from the aerobic tank toward the anoxic tank, and thus the power from the urging device may be efficiently consumed to transfer the treatment target water. The power unit located above the reference liquid level may facilitate maintenance.

The multilayer treatment tank according to one aspect of the present invention may further comprises a pit surrounding a portion of the upper surface of the anoxic tank at which the end of the second channel is open; and a diffuser tube connected to the pit.

In this structure, the gas released into the second channel (gas generated in the anoxic tank) produces an airlift effect to accelerate a downstream flow in the second channel and may reduce the power to be input to circulate the treatment target water.

In the multilayer treatment tank according to one aspect of the present invention, the diffuser tube is further connected to a water supply.

In this structure, the diffuser tube can be easily washed and is thus clogged less frequently, or the diffuser tube that has been clogged can be easily unclogged.

In the multilayer treatment tank according to one aspect of the present invention, the second channel includes a protruding portion located upward from an upper edge of the aerobic tank, the protruding portion has an upper surface covered with a plate having an opening, the opening connects with a third channel, and the third channel includes a flowmeter to measure a flow velocity of gas flowing through the third channel.

This structure can precisely and successively measure the flow velocity of the effluent gas from the anoxic tank. Thus, this structure may accurately and timely determine the reaction state in the anoxic tank. This structure can also determine the used capacity of the deodorization system based on the actual flow velocity of the effluent gas and thus may optimize the used capacity. The effluent gas successively generated in the anoxic tank urges the preceding effluent gas downstream in the third channel and thus may eliminate the power to guide the effluent gas to the deodorization system.

The multilayer treatment tank according to one aspect of the present invention may further comprises a nozzle disposed inside the protruding portion and configured to spray water.

This structure causes the nozzle to spray water onto the liquid surface at the protruding portion and thus may prevent accumulation of scum in the protruding portion.

The multilayer treatment tank according to one aspect of the present invention may further comprises a controller configured to obtain at least one parameter selected from the group consisting of inflow of raw water being a flow rate of raw water flowing into the anoxic tank, a measured value of raw water being a measured value associated with a water characteristic of the raw water, outflow of treated water being a flow rate of treated water flowing out of the aerobic tank, a measured value of treated water being a measured value associated with a characteristic of treated water flowing out of the aerobic tank, a water temperature in the anoxic tank, a water temperature in the aerobic tank, and a flow velocity of a fluid flowing through the second channel, and an amount of outflow gas being a measured value from the flowmeter, the controller being configured to perform an obtaining process for obtaining data sets each including the at least one parameter at a time point and the amount of outflow gas at the time point, a data group creating process for creating a data group by accumulating the data sets obtained at a plurality of time points, and a training process for building, based on the data group, a classifier configured to output, in response to the at least one parameter being input, a predicted value of the amount of outflow gas predicted based on the at least one parameter.

This structure can predict the amount of outflow gas based on the various measured values. This structure can thus predict a change in the operation state of the multilayer treatment tank and immediately respond unintended changes.

In the sewage treatment system according to one aspect of the present invention, the second channel includes a downward portion extending downward from the protruding portion to another end of the second channel being open in the aerobic tank, and the sewage treatment system allows a fluid in the downward portion to flow at a flow velocity of lower than or equal to 0.8 m per second when the urging device is in operation.

This structure reduces the likelihood of the gas that is to be separated in the protruding portion being involved into the flow toward the downstream aerobic tank and can easily separate the gas.

Further features and advantages of the present invention will become more apparent from the following description of exemplary and nonrestrictive embodiments with reference to the drawings.

### BRIEF DESCRIPTION OF THE DRAWINGS

The terms Fig., Figs., Figure, and Figures are used interchangeably in the specification to refer to the corresponding figures in the drawings.

FIG. 1 is a diagram of a sewage treatment system according to an embodiment.

FIG. 2 is a diagram showing the structure of a multilayer treatment tank according to the embodiment.

FIG. 3 is a control block diagram of the multilayer treatment tank according to the embodiment.

FIG. 4 is an example control block diagram of the sewage treatment system according to the embodiment.

FIG. 5 is an example control block diagram of the sewage treatment system according to the embodiment.

FIG. 6 is a diagram of a first connection hole in a first modification.

FIG. 7 is a diagram of a first connection hole in a second modification.

FIG. 8 is a diagram of a first connection hole in a third modification.

FIG. 9 is a diagram of a first connection hole in a fourth modification.

FIG. 10 is a diagram of a multilayer treatment tank according to another embodiment.

### DESCRIPTION OF THE INVENTION

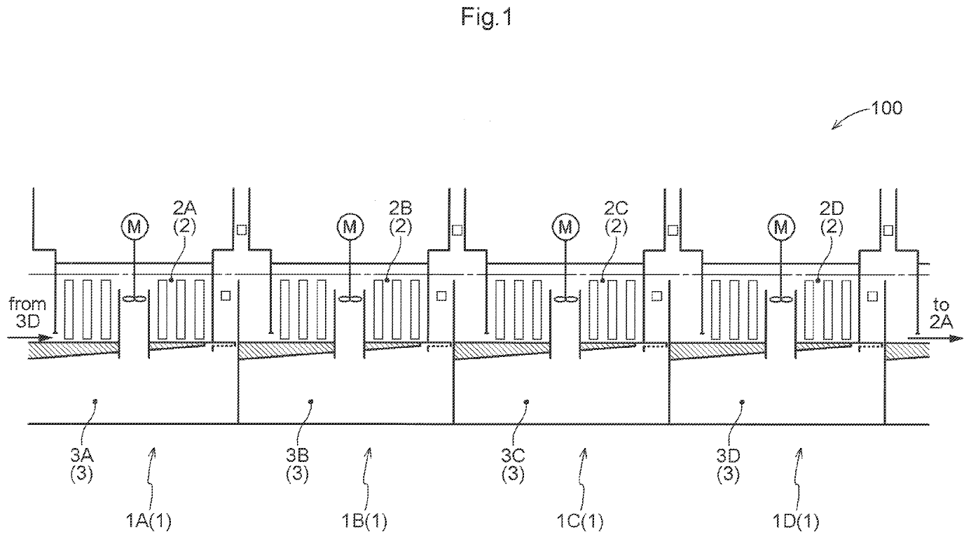

A multilayer treatment tank and a sewage treatment system according to embodiments of the present invention will be described with reference to the drawings. A sewage treatment system 100 (FIG. 1) including four multilayer treatment tanks 1 (1A, 1B, 1C, and 1D) will be described below as an example.

### Structure of Sewage Treatment System

The sewage treatment system 100 includes the multilayer treatment tank 1A, the multilayer treatment tank 1B, the multilayer treatment tank 1C, and the multilayer treatment tank 1D connected in this order. The multilayer treatment tank 1A is also connected downstream from the multilayer treatment tank 1D to form a circulatory system used for activated sewage treatment through circulating nitrification-denitrification (FIG. 1). In the sewage treatment system 100, more specifically, treatment target water sequentially flows through an aerobic tank 2A in the multilayer treatment tank 1A, an anoxic tank 3A in the multilayer treatment tank 1A, an aerobic tank 2B in the multilayer treatment tank 1B, an anoxic tank 3B in the multilayer treatment tank 1B, an aerobic tank 2C in the multilayer treatment tank 1C, an anoxic tank 3C in the multilayer treatment tank 1C, an aerobic tank 2D in the multilayer treatment tank 1D, and an anoxic tank 3D in the multilayer treatment tank 1D. The aerobic tank 2A in the multilayer treatment tank 1A is connected to a downstream end of the anoxic tank 3D in the multilayer treatment tank 1D to form a circulatory system.

### Structure of Multilayer Treatment Tank

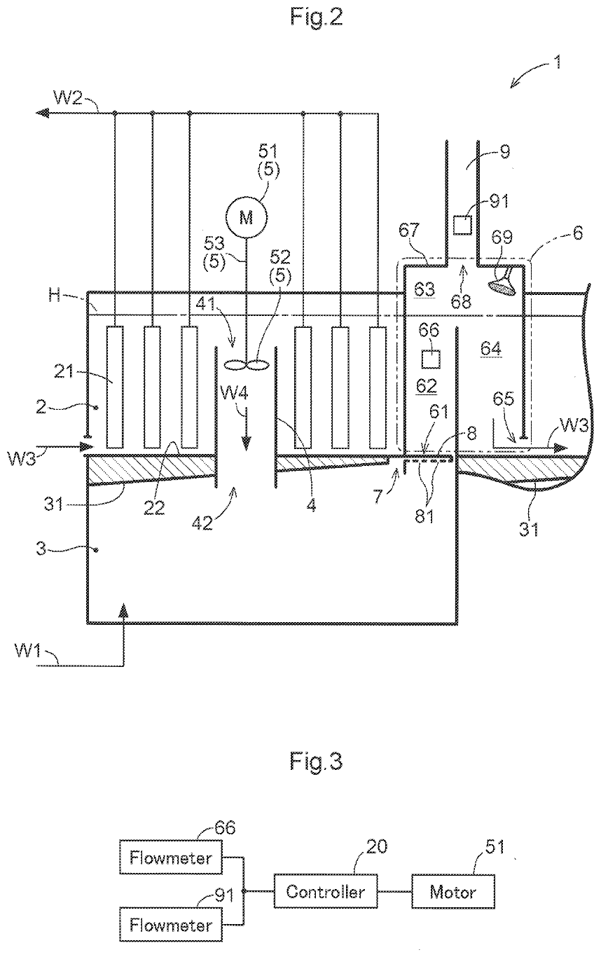

The multilayer treatment tank 1 according to the present embodiment is a two-layer sewage treatment tank including an aerobic tank 2 in the upper layer and an anoxic tank 3 in the lower layer (FIG. 2). In the aerobic tank 2, treated water is aerated to degrade ammonia nitrogen into nitrate ions by nitrifying bacteria. In the anoxic tank 3, nitrate ions are degraded into nitrogen gas by denitrifying bacteria. The multilayer treatment tank 1 thus degrades ammonia nitrogen in the aerobic tank 2 and nitrate ions in the anoxic tank 3 to degrade organic nitrogen contained in raw water W1 (such as domestic wastewater). A controller 20 controls the operations of the components of the multilayer treatment tank 1 (FIG. 3). More specifically, the controller 20 is a computer.

Although described in detail later, with multiple multilayer treatment tanks 1 according to the present embodiment, denitrified water W3 is denitrified in an anoxic tank 3 in a multilayer treatment tank 1 (e.g., multilayer treatment tank 1A), and is then transferred to an aerobic tank 2 in an adjacent multilayer treatment tank 1 (e.g., multilayer treatment tank 1B). A nitrified water W4 is nitrified in the aerobic tank 2 in the multilayer treatment tank 1 (e.g., multilayer treatment tank 1B), and is then transferred to an anoxic tank 3 in the same multilayer treatment tank 1 (e.g., multilayer treatment tank 1B).

### (Structure of Aerobic Tank)

The aerobic tank 2 is located in the upper layer of the multilayer treatment tank 1. Multiple membrane separators 21 are located in the aerobic tank 2. The multilayer treatment tank 1 is thus used for a membrane bioreactor (MBR) process. Treated water W2 that has passed through the membrane separators 21 is transferred to the subsequent process. In the aerobic tank 2, a reference liquid level or a liquid level in the normal operation state of the multilayer treatment tank 1 is set, and the membrane separators 21 are located below the reference liquid level. FIG. 2 shows the reference liquid level with a dot-dash line H. The denitrified water W3 treated in another upstream multilayer treatment tank 1 located upstream flows into the aerobic tank 2, and nitrifying bacteria degrade ammonia nitrogen. An aerator (not shown) is located in the aerobic tank 2.

A draft tube 4 (an example of a first channel or an example of a duct) and an agitator 5 (an example of an urging device) are located at the center of the aerobic tank 2.

The draft tube 4 extends vertically at the center of the aerobic tank 2 to allow a fluid to flow between the aerobic tank 2 and the anoxic tank 3. The draft tube 4 has an upper end 41 open near and below the reference liquid level (e.g., at a height of four-fifths of the reference liquid level from a bottom surface 22 of the aerobic tank 2). The draft tube 4 has a lower end 42 open in the anoxic tank 3.

The agitator 5 includes a motor 51 (an example of a power unit), an impeller 52 (an example of an urging unit), and a shaft 53. The motor 51 includes an inverter and can control the output. The controller 20 can output control signals to the agitator 5 (motor 51), and the control signals control the output of the motor 51. The motor 51 is located above the reference liquid level. Thus, the motor 51 is located above the liquid surface when the multilayer treatment tank 1 is in a normal operation state. The motor 51 may not be drivable under water, and may be a typical motor usable in the atmosphere. Compared with a submersible pump that has been used in such a treatment tank and that is to be raised from under water for maintenance, the motor 51 in the present embodiment located in the atmosphere facilitates maintenance.

The impeller 52 is located below the reference liquid level, and attached with an orientation to urge a liquid in the aerobic tank 2 downward when driven with power from the motor 51. The shaft 53 transmits the power from the motor 51 to the impeller 52.

The impeller 52 is accommodated in the draft tube 4. Thus, the agitator 5 allows a downward flow of a nitrified water W4 inside the draft tube 4 when operated. Thus, the nitrified water W4 flows from the aerobic tank 2 into the anoxic tank 3 through the draft tube 4.

### (Structure of Anoxic Tank)

The anoxic tank 3 is located in the lower layer of the multilayer treatment tank 1 to receive the raw water W1 flowing into the multilayer treatment tank 1. The raw water W1 and the nitrified water W4 transferred from the aerobic tank 2 flow into the anoxic tank 3, and denitrifying bacteria degrade nitrate ions to generate nitrogen gas.

The lower end 42 of the draft tube 4 and a lower end 61 (an example of an end of a second channel) of a denitrified water channel 6 (an example of a second channel) are located in an upper surface 31 of the anoxic tank 3. The lower end 42 (an example of an end of a first channel) of the draft tube 4 protrudes into the anoxic tank 3 through the upper surface 31. More specifically, at the lower end 42 of the draft tube 4, the channel (or the channel in the draft tube 4) is defined by a wall surface (or a solid portion of the draft tube 4) protruding into the anoxic tank 3 through the upper surface 31 of the anoxic tank 3.

The upper surface 31 of the anoxic tank 3 is sloped with respect to the horizontal direction. More specifically, the upper surface 31 may be sloped with respect to the horizontal direction at an inclination of 1° to 20° inclusive. The lower end 61 of the denitrified water channel 6 is located at the upper end of the slope. Thus, the gas (e.g., nitrogen gas) generated in the anoxic tank 3 flows upward along the sloped upper surface 31 to the lower end 61 of the denitrified water channel 6. The lower end 42 of the draft tube 4 protrudes into the anoxic tank 3 through the upper surface 31. Thus, the gas flowing along the sloped upper surface 31 is less likely to flow into the lower end 42 of the draft tube 4. The upper surface 31 may be a plane without unevenness to reduce accumulation of scum.

More specifically, a pit 7 is located at the upper end of the upper surface 31, and the gas flowing upward along the sloped upper surface 31 gathers around the pit 7. A diffuser tube 8 is connected to the pit 7. The gas gathering around the pit 7 flows into the denitrified water channel 6 through pores 81 in the diffuser tube 8. Thus, the gas released into the denitrified water channel 6 produces an airlift effect to accelerate a downstream flow and may reduce the power to be input (more specifically, to be input as the power of the motor 51) to circulate the treatment target water in the sewage treatment system 100.

The other end of the diffuser tube 8 (the end opposite to the end connected to the pit 7) is connected to a water supply (not shown). With the water supplied from the water supply, the pores 81 in the diffuser tube 8 can be washed.

### (Structure of Denitrified Water Channel)

The denitrified water channel 6 is located between the anoxic tank 3 and the outside of the multilayer treatment tank 1. In the present embodiment, the denitrified water channel 6 has its downstream end connected to the aerobic tank 2 in an adjacent multilayer treatment tank 1 located downstream in the sewage treatment system 100. For example, the denitrified water channel 6 is located between the anoxic tank 3 in the multilayer treatment tank 1A and the aerobic tank 2 in the multilayer treatment tank 1B. Through the denitrified water channel 6, the denitrified water W3 is transferred from the anoxic tank 3 in the multilayer treatment tank 1A to the aerobic tank 2 in the multilayer treatment tank 1B. The gas generated in the anoxic tank 3 flows into the denitrified water channel 6, and through the denitrified water channel 6 together with the denitrified water W3.

The denitrified water channel 6 includes an upward portion 62 extending upward from the upper surface of the anoxic tank 3, a protruding portion 63 located upward from the upper end of the aerobic tank 2, and a downward portion 64 extending downward from the protruding portion 63 along the adjacent aerobic tank 2 to which the downward portion 64 is connected. The downward portion 64 has a distal end 65 open in a side surface of the adjacent aerobic tank 2 to which the distal end 65 is connected.

The upward portion 62 has a cross section of about one meter square. A flowmeter 66 to measure the flow velocity of the fluid (denitrified water W3) flowing through the upward portion 62 is located in the upward portion 62. The measured values from the flowmeter 66 are converted to electric signals and input into the controller 20. In the present embodiment, all the four multilayer treatment tanks 1 (1A, 1B, 1C, and 1D) include the flowmeter 66. Thus, each multilayer treatment tank 1 can independently measure the flow velocity of the denitrified water W3.

The protruding portion 63 is located upward from the upper end of the aerobic tank 2, and has an upper surface covered with a plate 67. The plate 67 has an opening 68, to which an effluent gas channel 9 (an example of a third channel) is connected. The protruding portion 63 is located upward from the upper end of the aerobic tank 2. Thus, the liquid surface in the protruding portion 63 is located at substantially the same height as the liquid level of the aerobic tank 2, and a gas phase forms above the liquid surface. Thus, the gas generated in the anoxic tank 3 is separated from the denitrified water W3 in the protruding portion 63.

The effluent gas channel 9 is connected to a deodorizing device (not shown). A flowmeter 91 is located on the channel to the deodorizing device to measure the flow velocity of gas (amount of outflow gas) flowing through the effluent gas channel 9. The measured values from the flowmeter 91 are converted to electric signals and input into the controller 20. In the present embodiment, all the four multilayer treatment tanks 1 (1A, 1B, 1C, and 1D) include the effluent gas channel 9 and the flowmeter 91. Thus, each multilayer treatment tank 1 can independently measure the amount of outflow gas.

A defoaming nozzle 69 (an example of a nozzle) is located in the protruding portion 63. Water sprayed onto the liquid surface of the denitrified water W3 from the defoaming nozzle 69 may prevent accumulation of scum in the protruding portion 63.

The downward portion 64 has a rectangular cross section with long sides of about 3 m and short sides of about 1 m. The downward portion 64 has a greater cross-sectional area than the upward portion 62. Thus, the denitrified water W3 in the downward portion 64 has a lower flow velocity than the denitrified water W3 in the upward portion 62. This structure with the lower flow velocity of the denitrified water W3 in the downward portion 64 reduces the likelihood of the gas that is to be separated in the protruding portion 63 being involved into the flow of the denitrified water W3, and can easily separate the gas. More specifically, during the operation of the agitator 5 (motor 51), the flow velocity of the denitrified water W3 (fluid) in the downward portion 64 may be lower than or equal to 0.8 m per second, or more specifically, 0.5 m per second. Such a flow velocity is obtained by appropriately setting an output from the agitator 5 (motor 51) and the cross-sectional area of the downward portion 64.

### Control of Multilayer Treatment Tank

A method for controlling the multilayer treatment tank 1 will now be described. The controller 20 is located in the multilayer treatment tank 1. The measured values from the flowmeter 66 (the flow velocity of a fluid flowing through the upward portion 62 of the denitrified water channel 6) and the measured values from the flowmeter 91 (the flow velocity of gas flowing through the effluent gas channel 9) are input into the controller 20. The controller 20 can output, to the agitator 5 (motor 51), control signals for controlling the output from the motor 51. More specifically, the controller 20 can implement the control function to control the agitator 5.

The controller 20 also receives inputs of various measured values including inflow of raw water that is the flow rate of the raw water W1 flowing into the anoxic tank 3, the raw water measured value (e.g., pH, biochemical oxygen demand or BOD, chemical oxygen demand or COD, suspended solid or SS, or nitrogen content) that is the measured values associated with the characteristics of the raw water W1, outflow of treated water that is the flow rate of the treated water W2 flowing out of the aerobic tank 2, the treated water measured value (e.g., pH, BOD, COD, SS, or nitrogen content) that is the measured value associated with the characteristics of the treated water flowing out of the aerobic tank 2, an anoxic tank water temperature that is the water temperature in the anoxic tank 3, and an aerobic tank water temperature that is the water temperature in the aerobic tank 2. These measured values may be directly input after being measured with a measuring device (not shown) located in the multilayer treatment tank 1, or may be inspection results performed on a sample taken from the multilayer treatment tank 1 and input manually.

In particular, the measured value (amount of outflow gas) from the flowmeter 91 is a notable index directly indicating the denitrification state in the anoxic tank 3. The structure according to the present embodiment can constantly monitor the amount of outflow gas with the flowmeter 91 and can constantly determine the denitrification state. The structure according to the present embodiment controls the operation of the agitator 5 (motor 51) based on the denitrification state, and thus may control the operation state of the entire multilayer treatment tank 1.

The multilayer treatment tank 1 according to the present embodiment simply includes the motor 51 as a power component. The motor 51 supplies energy for circulating the treatment target water in the multilayer treatment tank 1 (sewage treatment system 100) and energy for uniformly agitating sludge in the anoxic tank 3. When the motor 51 continues to operate with an output optimized for circulation of the treatment target water, agitation in the anoxic tank 3 may be excessive and denitrification may be insufficient. When the motor 51 continues to operate with an output optimized for agitation in the anoxic tank 3, circulation of the treatment target water may be insufficient.

In the present embodiment, the controller 20 thus has the control function of setting an operation mode of the agitator 5 (motor 51) to a first operation mode of driving the motor 51 with an output (first output) optimized for circulation of the treatment target water, or a second operation mode of driving the motor 51 with an output (second output) optimized for agitation in the anoxic tank 3. The second output is smaller than the first output. The first operation mode and the second operation mode are alternated to cause circulation of the treatment target water and agitation in the anoxic tank 3 both at intended levels.

The controller 20 can perform an obtaining process of obtaining a data set of at least one parameter at a specific time point and a measured value (amount of outflow gas) from the flowmeter 91 at the time point, a data group creating process of creating a data group by accumulating data sets at multiple time points, and a learning process of building, based on the data group created in the data group creating process, a classifier that can output a predicted value of an amount of outflow gas predicted based on the parameter in response to an input of at least one parameter. The parameter is selected from the above various measured values to serve as a parameter that can be input into the controller 20, for example, a measured value from the flowmeter 66 (the flow velocity of a fluid flowing through the upward portion 62 of the denitrified water channel 6), inflow of raw water that is the flow rate of the raw water W1 flowing into the anoxic tank 3, or outflow of treated water that is the flow rate of the treated water W2 flowing out of the aerobic tank 2.

The classifier built through the obtaining process, the data group creating process, and the learning process can predict the amount of outflow gas based on the various measured values such as a measured value from the flowmeter 66. This structure can predict the amount of outflow gas based on the various measured values. This structure can predict a change in the operation state of the multilayer treatment tank 1 and thus immediately respond to unintended changes.

### Control of Sewage Treatment System

Based on the method for controlling the multilayer treatment tank 1, a method for controlling the sewage treatment system 100 will be described further. In controlling the sewage treatment system 100, the multilayer treatment tanks 1 (1A, 1B, 1C, and 1D) are to be controlled uniformly. The structure according to the present embodiment uses a method for uniformly controlling the four multilayer treatment tanks 1.

In the present embodiment described above, all the four multilayer treatment tanks 1 can independently measure the flow velocity of the denitrified water W3 and the amount of outflow gas. Thus, the state of each multilayer treatment tank 1 can be independently determined. In other words, when the amount of outflow gas between the multilayer treatment tanks 1 is uniform, the four multilayer treatment tanks 1 can be operated uniformly.

In contrast, when the amount of outflow gas between the multilayer treatment tanks 1 is ununiform, the four multilayer treatment tanks 1 may be operated ununiformly. More specifically, any one of the multilayer treatment tanks 1 may have a malfunction. In such a case, the multilayer treatment tanks 1 undergo operations such as maintenance. More specifically, the uniformity of inflow of the raw water W1, the uniformity of the amount of dissolved oxygen (DO) in the aerobic tanks 2, the uniformity of the current values of the agitators 5 (motors 51), and the uniformity of the measurement flow velocity of the flowmeters 66 are inspected to estimate the cause of abnormality.

To uniformly operate the four multilayer treatment tanks 1, the operation mode of the agitators 5 (motors 51) may be changed synchronously. When one or more of the agitators 5 are operated in the first operation mode, and the other one or more agitators 5 are operated in the second operation mode, the outflow of treatment target water from the multilayer treatment tanks 1 with the agitators 5 operated in the first operation mode is greater than the outflow of treatment target water from the multilayer treatment tanks 1 with the agitators 5 operated in the second operation mode, and thus the amount of treatment target water varies between the multilayer treatment tanks 1. More specifically, all the agitators 5 may be set to operate in the same operation mode. More specifically, all the agitators 5 may be set to operate in the same operation mode at the same timing.

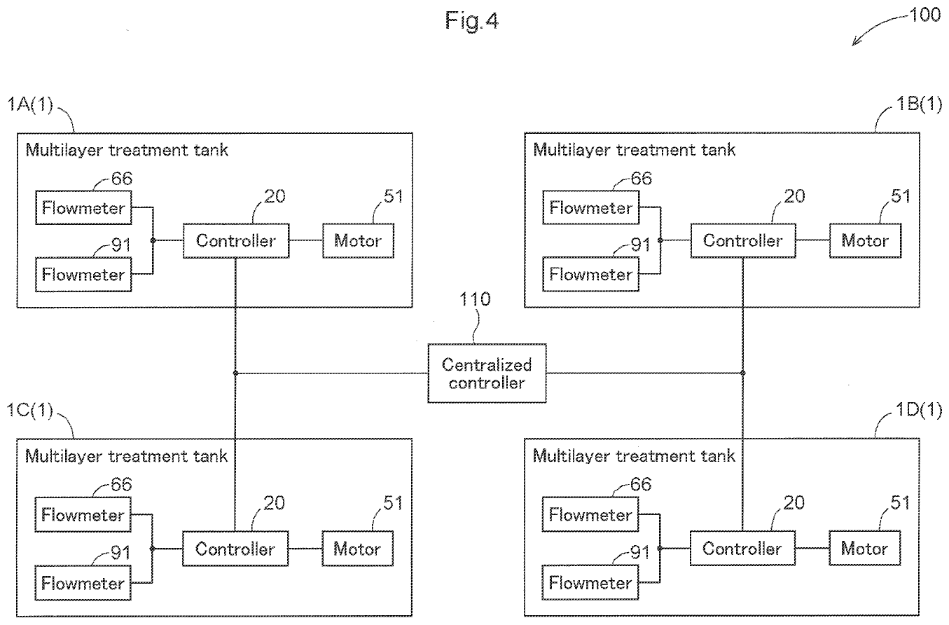

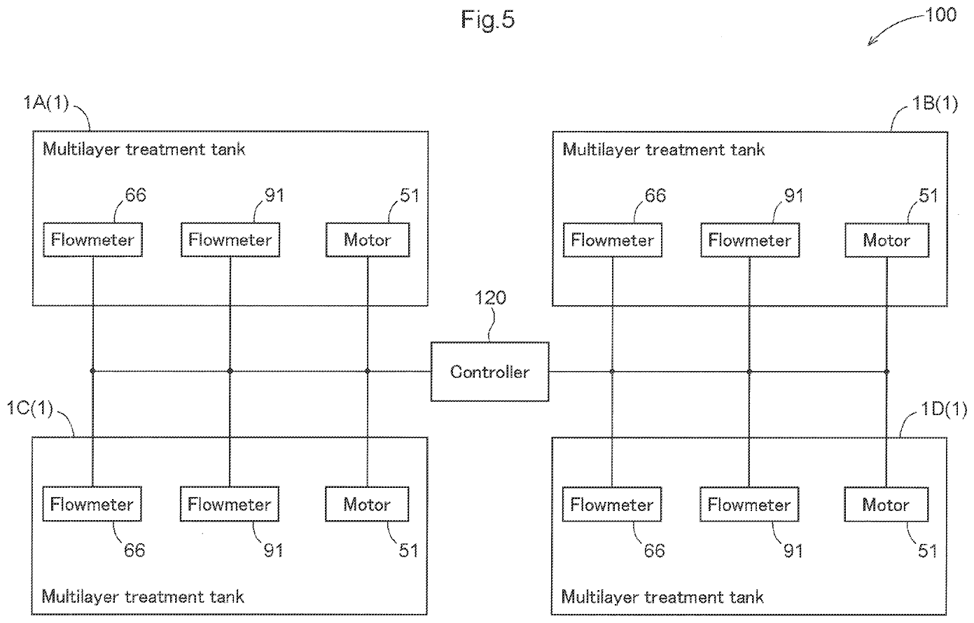

As a controller to perform the above control, a centralized controller 110 may be used (FIG. 4) to communicate with the four controllers 20 in the multilayer treatment tanks 1. The centralized controller 110 may centrally control the four controllers 20 (FIG. 4). In place of the controller 20 in each multilayer treatment tank 1, a single controller 120 may be used (FIG. 5) to integrally control the four multilayer treatment tanks 1.

### First Channel Modification

In the above embodiment, for example, the draft tube 4 is located as a first channel between the aerobic tank 2 and the anoxic tank 3. However, the first channel in one or more embodiments of the present invention is not limited to this example.

### First Modification

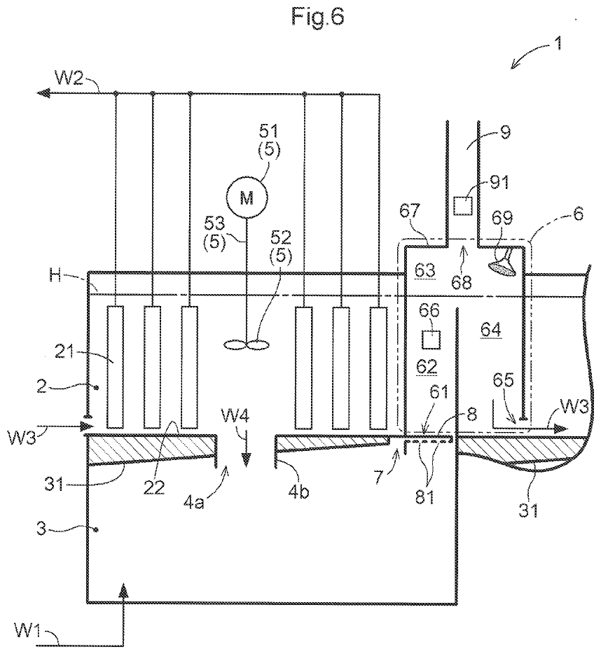

A first channel in a first modification (FIG. 6) is a through-hole 4a between the bottom surface 22 of the aerobic tank 2 and the upper surface 31 of the anoxic tank 3. A structure with a wall surface 4b defining the first channel may be located to protrude into the anoxic tank 3 through the upper surface 31 of the anoxic tank 3, producing the same effects as the structure with the lower end 42 of the draft tube 4 protruding into the anoxic tank 3 (FIG. 2). The wall surface 4b may be located along the edge of the through-hole 4a or spaced from the edge of the through-hole 4a. When the edge of the through-hole 4a and the wall surface 4b are spaced sufficiently from each other, gas is highly likely to flow backward through the through-hole 4a. Thus, when the edge of the through-hole 4a and the wall surface 4b are spaced, they are to be spaced by a distance within a range in which the wall surface 4b technically defines the first channel continuous with the through-hole 4a.

### Second Modification

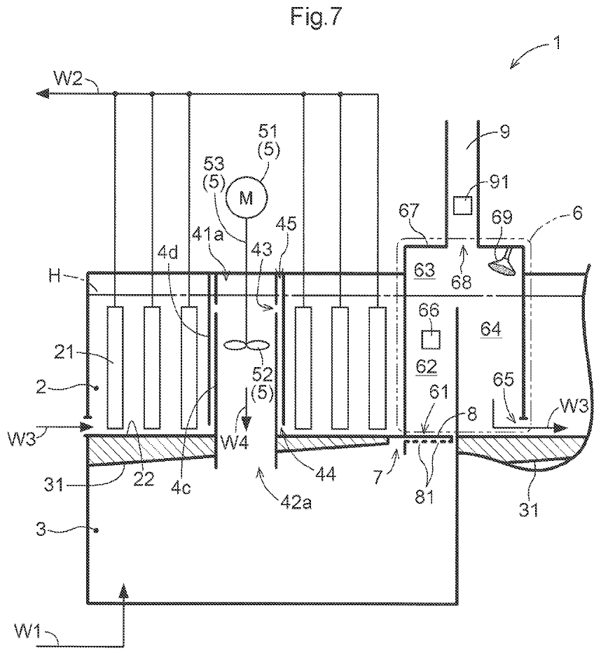

A first channel in a second modification (FIG. 7) includes a draft tube 4c (an example of a duct) and a sheath 4d surrounding the draft tube 4c. The draft tube 4c has a lower end 42a (one end) open in the anoxic tank 3, and an upper end 41a (the other end) located above the reference liquid level. A connection hole 43 that connects the inside of the draft tube 4c and the inside of the sheath 4d with each other is located near the reference liquid level of the draft tube 4c. The sheath 4d has a lower end 44 (one end) open near the bottom surface 22 of the aerobic tank 2, and an upper end 45 (the other end) located above the reference liquid level. The connection hole 43 may be at a position higher than two thirds of the reference liquid level from the bottom surface 22 of the aerobic tank 2, or more specifically, four fifths of the reference liquid level. The lower end 44 of the sheath 4d may be open at a position lower than two thirds of the reference liquid level from the bottom surface 22 of the aerobic tank 2, or more specifically, half of the reference liquid level, or still more specifically, one third of the reference liquid level.

In the second modification with the above structure, when the agitator 5 is in operation, the liquid in the aerobic tank 2 enters the sheath 4d from the lower end 44 of the sheath 4d, and sequentially flows through the connection hole 43 and the draft tube 4c into the anoxic tank 3. In the anoxic tank 3, to maintain the activity of the denitrifying bacteria, the amount of DO is to be kept at or below a specific level. The amount of dissolved oxygen in the aerobic tank 2 varies depending on the depth from the water surface. The nitrified water W4 taken from a portion with a relatively lower amount of dissolved oxygen may thus be supplied to the anoxic tank 3. In the second modification, the nitrified water W4 taken from near the bottom of the aerobic tank 2 with a relatively lower amount of dissolved oxygen is supplied to the anoxic tank 3, thus reducing an increase of the amount of dissolved oxygen in the anoxic tank 3.

### Third Modification

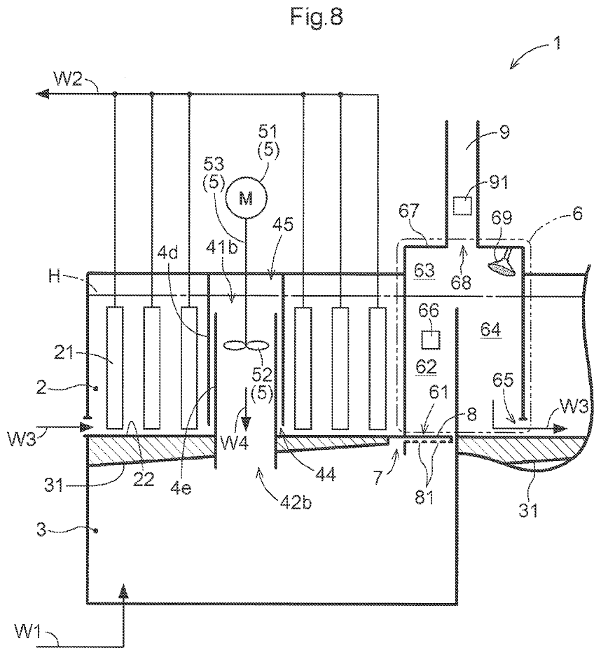

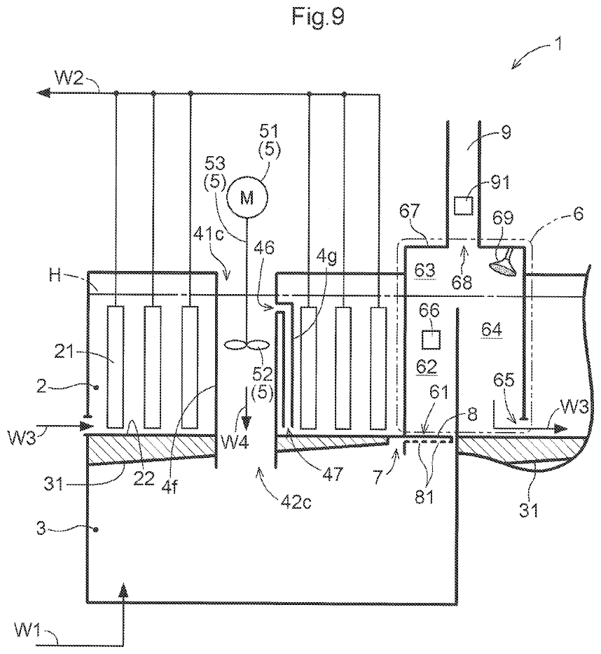

A first channel in a third modification (FIG. 8) includes a draft tube 4e (an example of a duct) and a sheath 4d surrounding the draft tube 4e. The sheath 4d has the same structure as in the second modification (FIG. 7), and is denoted with the same reference sign. The third modification is different from the second modification in that the draft tube 4e has an upper end 41b (the other end) located below the reference liquid level. The structure in the second modification includes the connection hole 43 that connects the inside of the draft tube 4c and the inside of the sheath 4d with each other, whereas, in the third modification, the inside of the draft tube 4e and the inside of the sheath 4d are connected at the upper end 41b of the draft tube 4e.

### Fourth Modification

A first channel in a fourth modification (FIG. 9) includes a draft tube 4f (an example of a duct) and a suction pipe 4g extending from the side surface of the draft tube 4f and connected to the inside of the draft tube 4f. The draft tube 4f has a lower end 42c (one end) open in the anoxic tank 3, and an upper end 41c (the other end) located above the reference liquid level. The suction pipe 4g includes a basal end 46 connected to the draft tube 4f near the reference liquid level and a distal end 47 open near the bottom surface 22 of the aerobic tank 2. The basal end 46 of the suction pipe 4g may be at a position higher than two thirds of the reference liquid level from the bottom surface 22 of the aerobic tank 2, or more specifically, four fifths of the reference liquid level. The distal end 47 of the suction pipe 4g may be open at a position lower than two thirds of the reference liquid level from the bottom surface 22 of the aerobic tank 2, or more specifically, half of the reference liquid level, or still more specifically, one third of the reference liquid level.

The suction pipe 4g may be a pipe with a fixed shape or a deformable pipe (or a flexible tube). One or more suction pipes 4g may be used.

### OTHER EMBODIMENTS

A multilayer treatment tank and a sewage treatment system according to other embodiments of the present invention will be described. The structure described in each of the embodiments below may be combined with any other structures described in other embodiments unless any contradiction arises.

In the above embodiment, for example, the multiple membrane separators 21 are located in the aerobic tank 2. However, the aerobic tank in one or more embodiments of the present invention is not limited to a structure including membrane separators, and an aerobic tank known in the field may be used.

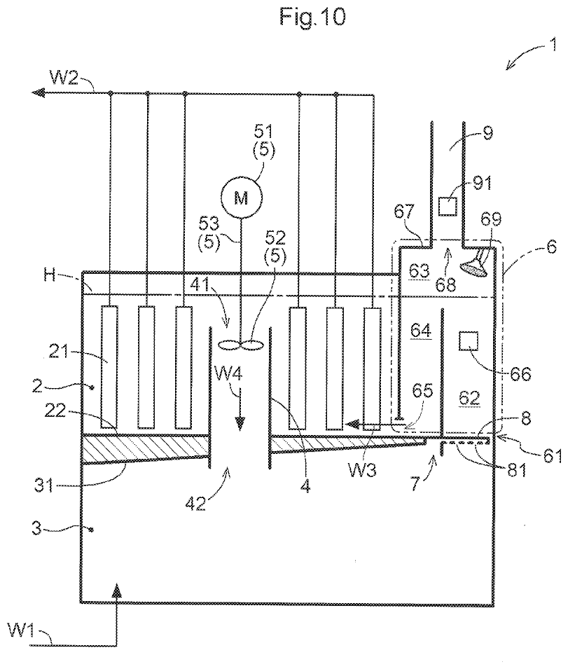

The above embodiment is described based on the sewage treatment system 100 including the four multilayer treatment tanks 1 (1A, 1B, 1C, and 1D) as an example. However, a sewage treatment system according to one or more embodiments of the present invention may include any number of multilayer treatment tanks 1, or one or more multilayer treatment tanks 1. FIG. 10 shows an example of the sewage treatment system including a single multilayer treatment tank. In this example, the denitrified water channel 6 has a distal end 65 open in the aerobic tank 2 in the same multilayer treatment tank 1, thus forming a circulatory system that is integral in the single multilayer treatment tank 1.

In the above embodiment, for example, the multilayer treatment tank 1 includes the aerobic tank 2 and the anoxic tank 3 to be used for activated sewage treatment through circulating nitrification-denitrification. However, the multilayer treatment tank 1 may be used for sewage treatment with any method. When the multilayer treatment tank 1 is used for sewage treatment with another method, another tank (e.g., an anaerobic tank) used for sewage treatment with the method may be integral with or separate from the multilayer treatment tank according to one or more embodiments of the present invention.

In the above embodiment, for example, the multiple membrane separators 21 are located in the aerobic tank 2, and the multilayer treatment tank 1 is used for the MBR process. However, the multilayer treatment tank according to one or more embodiments of the present invention may be used for sewage treatment with any method. When the multilayer treatment tank is used for sewage treatment with another method, devices, equipment, or other components used in the sewage treatment with the method may be integral with or separate from the multilayer treatment tank according to one or more embodiments of the present invention.

In the above embodiment, for example, the agitator 5 including the motor 51, the impeller 52, and the shaft 53 is located in the aerobic tank 2. The urging device in the multilayer treatment tank according to one or more embodiments of the present invention may have any structure and be located at any position to allow a flow into the anoxic tank from the aerobic tank through the first channel when the urging device is in operation. For example, the agitator may be a submersible pump.

In the above embodiment, for example, the upper surface 31 of the anoxic tank 3 is sloped. However, the upper surface of the anoxic tank in one or more embodiments of the present invention may be horizontal.

In the above embodiment, for example, the pit 7 and the diffuser tube 8 are located in the anoxic tank 3, and the gas generated in the anoxic tank 3 flows through the pit 7 and the diffuser tube 8 into the denitrified water channel 6. However, the gas generated in the anoxic tank 3 may directly flow into the denitrified water channel 6 in the multilayer treatment tank according to one or more embodiments of the present invention. In the above embodiment, for example, the diffuser tube 8 is connected to the water supply. However, the diffuser tube may not be connected to a water supply.

In the above embodiment, for example, the denitrified water channel 6 includes the protruding portion 63. In the multilayer treatment tank according to one or more embodiments of the present invention, the denitrified water channel may not include a protruding portion. When the denitrified water channel includes a protruding portion, the upper surface of the protruding portion may be open.

In the above embodiment, for example, the flowmeter 66 is located in the upward portion 62 of the denitrified water channel 6, and the flowmeter 91 is located in the effluent gas channel 9. However, the multilayer treatment tank according to one or more embodiments of the present invention may not include such flowmeters, and one of or both the flowmeters may be eliminated.

In the above embodiment, for example, the defoaming nozzle 69 is located in the protruding portion 63 of the denitrified water channel 6. However, the multilayer treatment tank according to one or more embodiments of the present invention may not include a defoaming nozzle.

In the above embodiment, for example, the measured value from the flowmeter 66 and the measured value from the flowmeter 91 are input into the controller 20, and the controller 20 can output control signals to the agitator 5 (motor 51). In the multilayer treatment tank according to one or more embodiments of the present invention, the controller may have any structure and may perform any control method, and a controller suitable for a selected control method may be used. The controller may be connected to another component with any method selected as appropriate for the selected control method, or various measurement devices may have any specifications and may be located at any position selected as appropriate for the selected control method.

For other structures as well, the embodiments herein are mere examples in all respects and should not be understood to restrict the scope of the present invention. Those skilled in the art will readily understand that modifications can be implemented as appropriate without departing from the sprit and scope of the invention. Other embodiments with modifications not departing from the sprit and scope of the invention thus fall within the scope of the invention.

### INDUSTRIAL APPLICABILITY

One or more embodiments of the present invention is usable for, for example, a treatment tank and a sewage treatment system used for activated sewage treatment through circulating nitrification-denitrification.

### REFERENCE SIGNS LIST

1 multilayer treatment tank
2 aerobic tank
21 membrane separator
22 bottom surface of aerobic tank
3 anoxic tank
31 upper surface of anoxic tank
4 draft tube
41 upper end of draft tube
42 lower end of draft tube
5 agitator
51 motor
52 impeller
53 shaft
6 denitrified water channel
61 lower end of denitrified water channel
62 upward portion
63 protruding portion
64 downward portion
65 distal end of denitrified water channel
66 flowmeter
67 plate
68 opening
69 defoaming nozzle
7 pit
8 diffuser tube
81 pore
9 third channel
91 flowmeter
20 controller
100 sewage treatment system
110 centralized controller
120 controller
W1 raw water
W2 treated water
W3 denitrified water
W4 nitrified water
H broken line indicating reference liquid level

### (First Modification)

4a through-hole
4b wall surface

### (Second Modification)

4c draft tube
4d sheath
41a upper end of draft tube
42a lower end of draft tube
43 connection hole
44 lower end of sheath
45 upper end of sheath

### (Third Modification)

4e draft tube
41b upper end of draft tube
42b lower end of draft tube

### (Fourth Modification)

4f draft tube
4g suction pipe
41c upper end of draft tube
42c lower end of draft tube
46 basal end of suction pipe
47 distal end of suction pipe

1. A multilayer treatment tank comprising an aerobic tank in an upper layer and an anoxic tank in a lower layer, the multilayer treatment tank comprising:
a first channel between the aerobic tank and the anoxic tank;
a second channel between the anoxic tank and a tank different from the anoxic tank; and
an urging device configured to urge a fluid, and
wherein:
the first channel and the urging device are located to allow a flow into the anoxic tank from the aerobic tank through the first channel when the urging device is in operation,
the second channel has an end being open in an upper surface of the anoxic tank, and
the first channel is defined by a wall with an end extending through the upper surface into the anoxic tank.

2. The multilayer treatment tank according to claim 1, wherein;
the upper surface of the anoxic tank is sloped, and
the end of the second channel is at an upper end of the sloped upper surface.

3. The multilayer treatment tank according to claim 1, wherein;
the first channel comprises a duct extending into the aerobic tank,
the aerobic tank has a reference liquid level set as a liquid level in a normal operation state,
the urging device comprises a power unit located above the reference liquid level, and an urging unit located below the reference liquid level to urge the fluid when driven with power from the power unit, and
the urging unit is accommodated in the duct.

4. The multilayer treatment tank according to claim 1, further comprising:
a pit surrounding a portion of the upper surface of the anoxic tank at which the end of the second channel is open; and
a diffuser tube connected to the pit.

5. The multilayer treatment tank according to claim 4, wherein:
the diffuser tube is further connected to a water supply.

6. The multilayer treatment tank according to claim 1, wherein;
the second channel comprises a protruding portion located upward from an upper edge of the aerobic tank,
the protruding portion has an upper surface covered with a plate having an opening,
the opening connects with a third channel, and
the third channel comprises a flowmeter to measure a flow velocity of gas flowing through the third channel.

7. The multilayer treatment tank according to claim 6, further comprising a nozzle disposed inside the protruding portion and configured to spray water.

8. The multilayer treatment tank according to claim 6, further comprising:
a controller configured to obtain;
at least one parameter selected from the group consisting of inflow of raw water that is a flow rate of raw water flowing into the anoxic tank, a measured value of raw water being a measured value associated with a water characteristic of the raw water, outflow of treated water that is a flow rate of treated water flowing out of the aerobic tank, a measured value of treated water that is a measured value associated with a characteristic of treated water flowing out of the aerobic tank, a water temperature in the anoxic tank, a water temperature in the aerobic tank, and a flow velocity of a fluid flowing through the second channel, and
an amount of outflow gas that is a measured value from the flowmeter, and
the controller is configured to perform:
an obtaining process for obtaining data sets each comprising the at least one parameter at a time point and the amount of outflow gas at the time point,
a data group creating process for creating a data group by accumulating the data sets obtained at a plurality of time points, and
a training process for building, based on the data group, a classifier configured to output, in response to the at least one parameter being input, a predicted value of the amount of outflow gas predicted based on the at least one parameter.

9. A sewage treatment system, comprising:
a plurality of multilayer treatment tanks, each of the plurality of multilayer treatment tanks comprising:
an aerobic tank in an upper layer;
an anoxic tank in a lower layer;
a first channel between the aerobic tank and the anoxic tank; and
an urging device configured to urge a fluid, and
wherein:
the plurality of multilayer treatment tanks forms a circulatory system in which the aerobic tanks and the anoxic tanks are alternately connected,
the first channel and the urging device are located to allow a flow into the anoxic tank from the aerobic tank through the first channel when the urging device is in operation,
the first channel is defined by a wall with an end extending through the upper surface into the anoxic tank,
two multilayer treatment tanks of the plurality of multilayer treatment tanks adjacent to each other in the circulatory system are connected with a second channel between the anoxic tank included in one of the two multilayer treatment tanks and the aerobic tank included in another of the two multilayer treatment tanks,
the second channel comprises an end open in the upper surface of the anoxic tank,
the second channel comprises a protruding portion located upward from an upper edge of the aerobic tank in each of the two multilayer treatment tanks connected with the second channel,
the protruding portion has an upper surface being covered with a plate having an opening,
the opening connects with a third channel, and
the third channel in each of the two multilayer treatment tanks comprises a flowmeter to measure a flow velocity of gas flowing through the third channel.

10. The sewage treatment system according to claim 9, wherein:
the second channel comprises a downward portion extending downward from the protruding portion to another end of the second channel being open in the aerobic tank, and
the sewage treatment system allows a fluid in the downward portion to flow at a flow velocity of lower than or equal to 0.8 m per second when the urging device is in operation.
